(19) United States
(12) Patent Application Publication
(10) Pub. No.: US 2010/0061027 A1
(43) Pub. Date: Mar. 11, 2010

(54) Interface circuit with electro-static discharge protection circuit

(75) Inventor: An-Xing Jiang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/584,636

(22) Filed: Sep. 8, 2009

(30) Foreign Application Priority Data
Sep. 5, 2008 (CN) 200810216043.8

(51) Int. Cl. H02H 9/04

(52) U.S. Cl. 361/56

(57) ABSTRACT

An exemplary interface circuit with an electrostatic discharge (ESD) protection circuit includes an interface and an ESD protection circuit. The interface includes at least two pins. The ESD protection circuit includes at least a first polarity signal enable circuit, a second polarity signal enable circuit, and an ESD circuit. The at least two pins are grounded via the at least first polarity signal enable circuit, the second polarity signal enable circuit, and share the same ESD circuit.

### BACKGROUND

1. Technical Field

The present disclosure relates to electrostatic discharge (ESD) protection, and particularly to an interface circuit with an ESD protection circuit.

2. Description of Related Art

ESD protection is generally important in electrical device design to prevent or minimize damage to the device not from static electricity. ESD protection circuits are particularly important in interface circuitry.

Referring to FIG. 3, a typical interface circuit 1 includes an interface 11 and two ESD protection circuits 12. The interface 11 includes a first pin 110 and a second pin 111. The two pins 110, 111 are grounded via the two ESD protection circuits 12, respectively.

The ESD protection circuit 12 includes a first diode 121, a second diode 122, a first Zener diode 123, and a second Zener diode 124. A positive electrode of the first diode 121 is connected to the positive electrode of the first Zener diode 123. The second pin 111 is connected to a negative electrode of the first diode 121 and is grounded via the series connected first diode 121 and the first Zener diode 123. The second pin 111 is also connected to a negative electrode of the second Zener diode 124 and is grounded via the series connected second Zener diode 124 and the second diode 122.

In the interface circuit 1, each pin needs an ESD protection circuit 12, and each ESD protection circuit 12 includes two diodes and two Zener diodes. The Zener diode is expensive, and costs of the interface circuit 1 are increased, especially where many Zener diodes are needed.

What is needed, therefore, is an interface circuit with an ESD protection circuit that can overcome the described limitations.

### BRIEF DESCRIPTION OF THE DRAWINGS

FIG. 1 is a circuit diagram of a first embodiment of an interface circuit with an ESD protection circuit according to the present disclosure.

FIG. 2 is a circuit diagram of a second embodiment of an interface circuit with an ESD protection circuit according to the present disclosure.

FIG. 3 is a circuit diagram of a conventional interface circuit.

### DETAILED DESCRIPTION

Reference will now be made to the drawings to describe various embodiments of the present disclosure in detail.

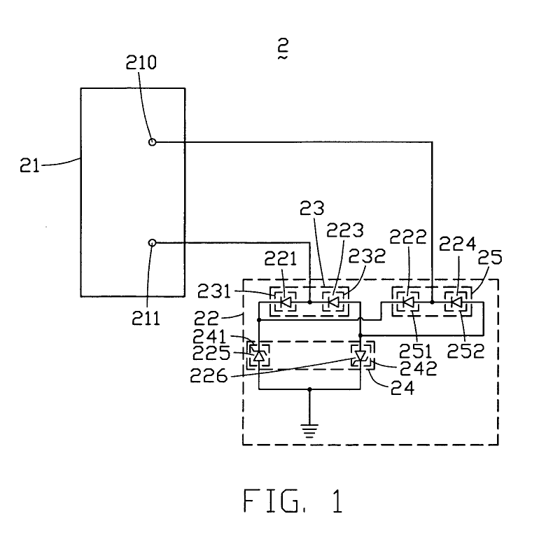

Referring to FIG. 1, an interface circuit with an electrostatic discharge (ESD) protection circuit 2 includes an interface 21 and an ESD protection circuit 22. The interface 21 includes a first pin 210 and a second pin 211. The interface 21 may be high definition multimedia interface (HDMI), video graphic array (VGA), digital visual interface (DVI), and/or USB interface.

The ESD protection circuit 22 includes a first polarity signal enable circuit 23, a second polarity signal enable circuit 25, and an ESD circuit 24. The first pin 210 is grounded via the series connected first polarity signal enable circuit 23 and the ESD circuit 24. The second pin 211 is grounded via the series connected second polarity signal enable circuit 25 and the ESD circuit 24.

The first polarity signal enable circuit 23 includes a first positive polarity signal enable circuit 231 and a first negative polarity signal enable circuit 232. The second polarity signal enable circuit 25 includes a second positive polarity signal enable circuit 251 and a second negative polarity signal enable circuit 252. The ESD circuit 24 includes a positive ESD circuit 241 and a negative ESD circuit 242. In this disclosure, the first positive polarity signal enable circuit 231 includes a first diode 221. The first negative polarity signal enable circuit 232 includes a third diode 223. The second positive polarity signal enable circuit 251 includes a second diode 222. The second negative polarity signal enable circuit 252 includes a fourth diode 224. The positive ESD circuit 241 includes a first Zener diode 225, and the negative ESD circuit 242 includes a second Zener diode 226.

A positive electrode of the first diode 221 and a negative electrode of the third diode 223 are both connected to the second pin 211. A positive electrode of the second diode 222 and a negative electrode of the fourth diode 224 are both connected to the first pin 210. A negative electrode of the first diode 221 and a negative electrode of the second diode 222 are both connected to a negative electrode of the first Zener diode 225. A positive electrode of the third diode 223 and a positive electrode of the fourth diode 224 are both connected to a positive electrode of the second Zener diode 226. A positive electrode of the first Zener diode 225 and a negative electrode of the second Zener diode 226 are both grounded.

A breakdown voltage of the first Zener diode 225 and the second Zener diode 226 is substantially higher than a normal working voltage of the first and the second pins 210, 211. With this parameter, the first and the second pins 210, 211 are prevented from being grounded when the first and the second pins 210, 211 are working normally.

In operation, positive electrostatic pulses of the first pin 210 are guided to ground via the second diode 222 and the first Zener diode 225. Negative electrostatic pulses of the first pin 210 are guided to ground via the fourth diode 224 and the second Zener diode 226. Positive electrostatic pulses of the second pin 211 are guided to ground via the first diode 221 and the first Zener diode 225. Negative electrostatic pulses of the second pin 211 are guided to ground via the third diode 223 and the second Zener diode 226.

Unlike the conventional interface circuit, in the interface circuit 2, the first and the second pins 210, 211 are grounded via the first polarity signal enable circuit 23, the second polarity signal enable circuit 25, and the ESD circuit 24. The ESD circuit 24 is shared by the first and the second pins 210, 211. Therefore, the number of required Zener diodes is few, keeping the cost low.

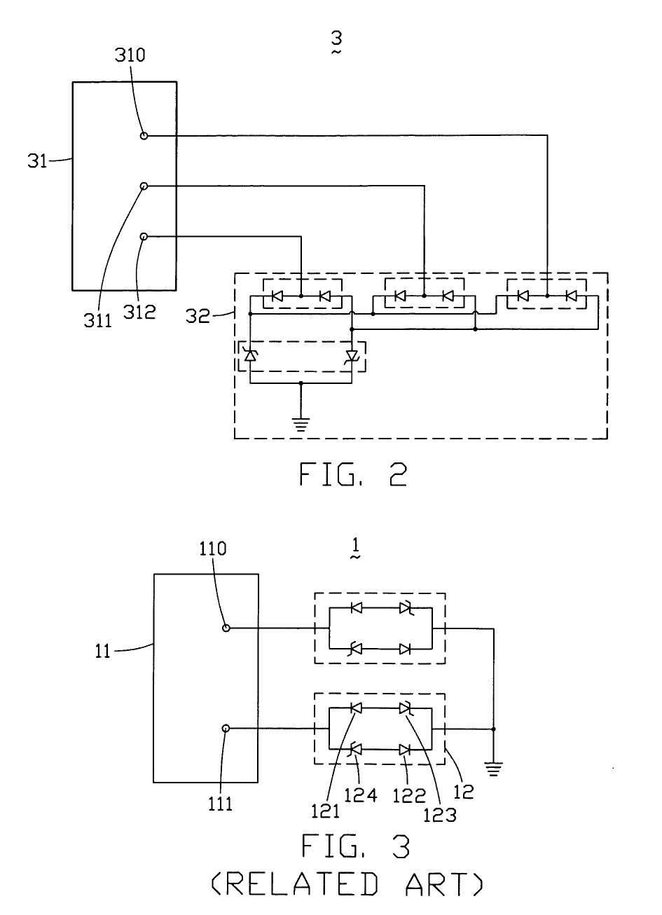

FIG. 2 shows a second embodiment of an interface circuit 3, differing from interface circuit 2 of the first embodiment only in the inclusion of an interface 31 including a first pin 310, a second pin 311, and a third pin 312. Correspondingly, an ESD protection circuit 32 of the interface circuit 3 includes a first polarity signal enable circuit (not labeled), a second polarity signal enable circuit (not labeled), a third polarity signal enable circuit (not labeled), and a shared ESD circuit (not labeled). The interface circuit 3 has advantages similar to those of the interface circuit 2. Furthermore, if an interface of an interface circuit has more pins, the interface circuit is more economical.

Further and/or alternative embodiments are described as follows. In the first embodiment, one of the four diodes 221, 222, 223, 224 may be grounded via a third Zener diode rather than the ESD circuit 24. For example, the first diode 221 may not be grounded via the first Zener diode 225, but rather via a third Zener diode. In another embodiment, the first pin 210 is grounded via only the second diode 222 and the first Zener diode 225, and the second pin 211 is grounded via only the first diode 221 and the first Zener diode 225. That is, each of the first polarity signal enable circuit 23 and the second polarity signal enable circuit 25 includes only one diode, and the ESD circuit 24 includes only one Zener diode. The first polarity signal enable circuit 23 and the second polarity signal enable circuit 25 share the Zener diode.

It is to be understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An interface circuit with an electrostatic discharge (ESD) protection circuit, comprising:
an interface comprising at least two pins; and
an ESD protection circuit, the ESD protection circuit comprising at least a first polarity signal enable circuit, a second polarity signal enable circuit, and an ESD circuit, the at least first polarity signal enable circuit and second polarity signal enable circuit being connected to the at least two pins, and being grounded via the same ESD circuit.

2. The interface circuit with an ESD protection circuit of claim 1, wherein the first polarity signal enable circuit comprises a first diode and second diode, the second polarity signal enable circuit comprises a third diode and a fourth diode, and the ESD circuit comprises a first Zener diode and a second Zener diode, both the first diode and third diode are grounded via the first Zener diode, and both the second diode and fourth diode are grounded via the second Zener diode.

3. The interface circuit with an ESD protection circuit of claim 2, wherein a breakdown voltage of the first Zener diode and the second Zener diode is higher than a normal working voltage of the first and the second pins.

4. The interface circuit with an ESD protection circuit of claim 1, wherein the interface comprises high definition multimedia interface (HDMI), video graphic array (VGA) interface, digital visual interface (DVI), and/or USB interface.

5. The interface circuit with an ESD protection circuit of claim 1, wherein the first polarity signal enable circuit comprises a first diode, the second polarity signal enable circuit comprises a second diode, and the ESD circuit comprises a first Zener diode, the first diode and the second diode share grounding through the first Zener diode.

6. An interface circuit with an electrostatic discharge (ESD) protection circuit, comprising:
an interface comprising a first pin and a second pin; and
an ESD protection circuit comprising a first diode, a second diode, and a first Zener diode, the first pin being grounded via the first diode and the first Zener diode, and the second pin being grounded via the second diode and the first Zener diode.

7. The interface circuit with an ESD protection circuit of claim 6, wherein the ESD protection circuit further comprises a third diode, a fourth diode, and a second Zener diode, the first pin also being grounded via the third diode and the second Zener diode, and the second pin being grounded via the fourth diode and the second Zener diode.

8. The interface circuit with an ESD protection circuit of claim 7, wherein a positive electrode of the first diode and a negative electrode of the third diode are both connected to the first pin, a positive electrode of the second diode and a negative electrode of the fourth diode are both connected to the second pin, a negative electrode of the first diode and a negative electrode of the second diode are both connected to a negative electrode of the first Zener diode, a positive electrode of the third diode and a positive electrode of the fourth diode are both connected to a positive electrode of the second Zener diode, a positive electrode of the first Zener diode and a negative electrode of the second Zener diode are both grounded.

9. The interface circuit with an ESD protection circuit of claim 8, wherein a breakdown voltage of the first Zener diode and the second Zener diode is higher than a normal working voltage of the first and the second pins.

10. The interface circuit with an ESD protection circuit of claim 6, wherein the interface comprises high definition multimedia interface (HDMI), video graphic array (VGA) interface, digital visual interface (DVI), and/or USB interface.
